(19) United States
(12) Patent Application Publication
(10) Pub. No.: US 2018/0137471 A1
(43) Pub. Date: May 17, 2018

(54) PHYSICAL LOCATION AWARE CALENDAR SYSTEM

(71) Applicant: International Business Machines Corporation, Armonk, NY (US)

(72) Inventors: Ali Y. Duale, Poughkeepsie, NY (US); Shailesh R. Gami, Poughkeepsie, NY (US); Louis P. Gomes, Poughkeepsie, NY (US); Rajaram B. Krishnamurthy, Pleasant Valley, NY (US)

(21) Appl. No.: 15/351,607

(22) Filed: Nov. 15, 2016

(51) Int. Cl. G06Q 10/10; G01C 21/34; G01C 21/36

(52) U.S. Cl. CPC G06Q 10/1095; G01C 21/3691; G01C 21/3697; G01C 21/343

(57) ABSTRACT

A method of scheduling appointments based on a location of a user includes identifying a geographic location of a user, receiving, through a processor, a new appointment request for a selected day, determining a location of the new appointment, determining, through the processor, whether an additional appointment exists for a selected time period including the selected day and adjacent days, identifying, through the processor, a location of the additional appointment, determining, through the processor, whether a geographic conflict exists between the location of the new appointment and the location of the additional appointment when receiving the new appointment request, and providing an alert to the user through a user interface if a geographic conflict exists.

### BACKGROUND

The present invention relates to calendar systems, and more specifically, to a physical location aware calendar system.

Many individuals rely on calendars to plan their days, weeks, months, etc. Calendars may be used to set reminders for upcoming events such as travel, meetings, and the like. In an example, a user may input various appointments into a calendar for a given day. Each appointment may be allotted a particular start time and a particular end time. Some calendar systems allow a user to also input a location for the appointment. The location information may be accessed by navigational applications to provide reminders that it may be time to leave in order to arrive at the particular appointment on time.

Occasionally, a user may add an afternoon appointment into an open time slot on a day in which a morning appointment is already scheduled. While not typically a concern, on occasion the morning appointment and the afternoon appointment may not be geographically compatible. For example, attending both meetings in person could prove difficult if the morning appointment was located in Los Angeles, Calif., and the afternoon appointment was scheduled for Fairfax, Va.

### SUMMARY

According to an exemplary embodiment, a method of scheduling appointments based on a location of a user includes identifying a geographic location of a user, receiving, through a processor, a new appointment request for a selected day. The method also includes determining a location of the new appointment. The method further includes determining, through the processor, whether an additional appointment exists for a selected time period including the selected day and adjacent days. Additionally, the method includes identifying, through the processor, a location of the additional appointment. A determination is made, through the processor, whether a geographic conflict exists between the location of the new appointment, and the location of the additional appointment when receiving the new appointment request. An alert is provided to the user through a user interface if a geographic conflict exists.

According to another aspect of an exemplary embodiment, a system for scheduling appointments based on a location of a user includes a central processor unit (CPU), a non-volatile memory operatively connected to the CPU, and a calendaring module configured to detect geographic location of a user and an existing appointment. The calendaring module includes computer readable program code embodied therewith. The computer readable program code, when executed by the CPU, causes the CPU to identify a geographic location of a user, receive, through a processor, a new appointment request for a selected day. A location of the new appointment is determined. A determination is made, through the processor, whether an additional appointment exists for a selected time period, including the selected day and adjacent days. A location of the additional appointment is identified, through the processor. A determination is made through the processor, whether a geographic conflict exists between the location of the new appointment and the location of the additional appointment when receiving the new appointment request. An alert is provided to the user through a user interface if a geographic conflict exists.

According to yet another aspect of an exemplary embodiment, a computer program product includes a computer useable medium including a computer readable program. The computer readable program, when executed on a computer, causes the computer to identify a geographic location of a user. A new appointment request for a selected day is received through a processor. A determination is made of a location of the new appointment. A determination is made, through the processor, whether an additional appointment exists for a selected time period including the selected day and adjacent days. A location of the additional appointment is identified through the processor. A determination is made, through the processor, whether a geographic conflict exists between the location of the new appointment and the location of the additional appointment when receiving the new appointment request. An alert is provided to the user through a user interface if a geographic conflict exists.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating a calendaring system including a geographic conflict identification module, in accordance with an aspect of an exemplary embodiment;

FIG. 2 is a flow chart illustrating a method of identifying geographic location conflicts associated with scheduling appointments in a calendaring system, in accordance with an aspect of an exemplary embodiment; and

FIG. 3 is a schematic block diagram of a general-purpose computer suitable for practicing the method of identifying geographic location conflicts associated with scheduling appointments in a calendaring system, in accordance with an aspect of an exemplary embodiment.

### DETAILED DESCRIPTION

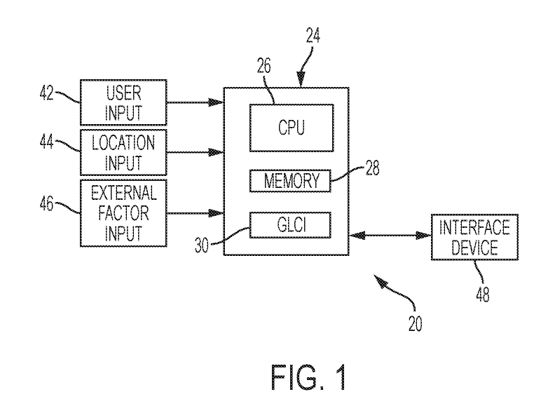

With reference now to FIG. 1 a calendaring system, in accordance with an aspect of an exemplary embodiment, is indicated generally at 20. Calendaring system 20 includes a calendaring module 24 that is based on a set of instructions and user inputs, creates, manages, and maintains a calendar including appointments, setting and providing reminders, and the like. Calendaring module may include, or be operatively associated with, a processor 26, a memory 28, and a geographic location conflict identification (GLCI) module 30.

Calendaring module 24 may receive inputs from, for example, a user input device 42, a location input device 44, an external factor input device 46 and may include an interface device 48 that may communicate with other devices such as smart devices, mobile computers, a GPS system, and the like. External factor input device 46 may provide weather information, traffic information, flight information, train information, and the like that could impact a user's ability to travel from one appointment to another. Interface device 48 may take the form of a wireless communication device, a wired communication device, and/or combinations thereof that allows calendaring module 24 to communicate directly and/or indirectly such as through the Internet, with one or more mobile devices, desktop devices, and the like.

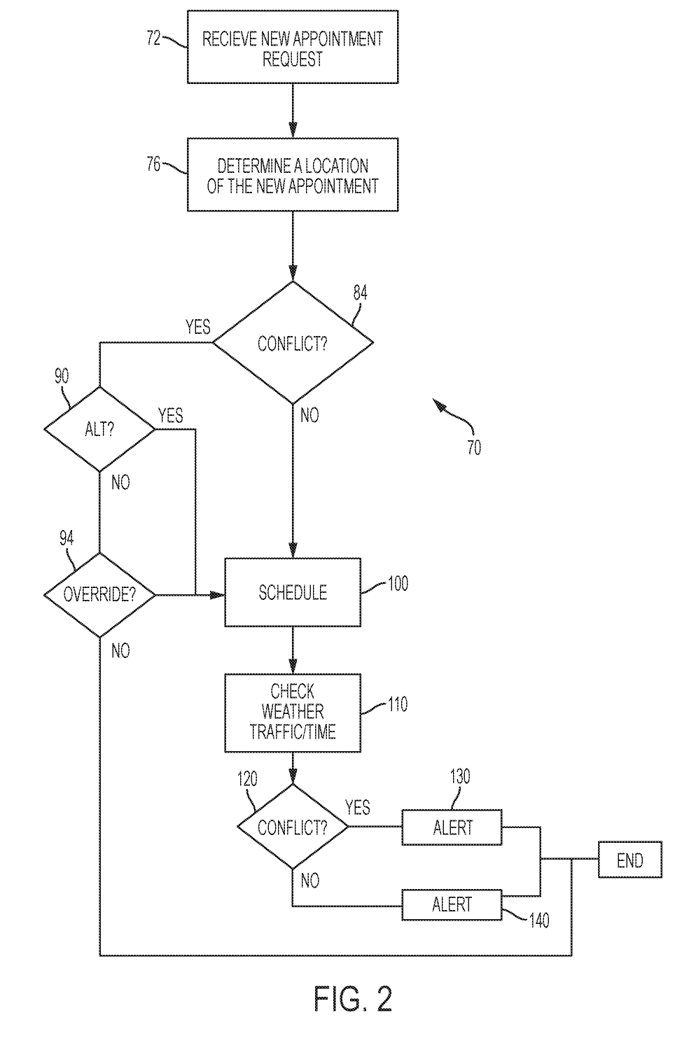

Reference will now follow to FIG. 2 in describing a method of identifying geographic location conflicts associated with scheduling appointments in calendaring system 20. A request for a new appointment on a selected day is received in block 72. In block 76, calendaring module 20 determines a location of the new appointment, and the location of the user. The location of the new appointment may be determined by direct user input, by interacting with memory 28 to identify any historical data or information that may be associated with the appointment request and/or through a search of the Internet. The location of the user may be determined by interacting with location information on the user's smart device, a GPS system, detecting an IP address of the user, reviewing the user's travel information and the like. In block 84, GLCI 30 determines whether a geographic conflict exists between the new appointment and another appointment scheduled on the selected day.

A “geographic conflict” should be understood to describe a situation in which a user cannot be in two places, in two different locations, on or about the same time. For example, a user cannot attend, in person, one meeting in Chicago at 9:00 AM and another meeting in Los Angeles at 7:00 AM. Another form of geographic conflict could represent a first meeting in one area of a city at one time, and a second meeting in another area of the city at another time, without sufficient travel time between locations. Other forms of geographic conflicts may also arise.

In block 84, if a conflict is determined to exist, calendaring system 20 may suggest alternatives such as dialing into the meeting, and/or changing times, alternative dates, or the like, for the new appointment in block 90. If no alternatives are available or acceptable, calendaring system 20 looks for an override command in block 94. If no override is received, the new appointment is not scheduled. If an alternative is acceptable, the new appointment is scheduled in block 100.

In block 84, if no geographic conflict exists when initially entered, the new appointment is scheduled in block 100. On or around the selected day for the appointment, calendaring system 20 may review data received through external factor input device 46 in block 110. Depending upon user preferences, and/or default settings, calendaring system 20 may review weather, traffic, flight and/or train data to determine if a new geographic conflict may arise. For example, if an accident occurs on a major travel artery, if flights are cancelled, trains are running late, or inclement weather, a user's ability to travel from one location to another may be impacted. More specifically, in a situation in which no conflicts externally, a conflict can arise as the selected day draws near or arrives. Thus, in accordance with an aspect of an exemplary embodiment, calendaring system 20 may determine if a new geographic conflict has arisen in block 120.

In block 120, if a new conflict arises, an alert may be sent to the user in block 130. A conflict may arise due to a current appointment running long, traffic related transportation concerns, and the like. The alert may provide details of the conflict allowing the user to determine options for moving forward with the appointment. For example, the alert may provide the user with a time to call to announce his delay in arrival, reschedule, or cut a current appointment short in order to arrive at the new appointment on time. If, in block 120, no conflict is shown to exist, calendaring system 20 may provide the user with an alert in block 140 that sets a desired departure time. The desired departure time may take into account current weather, traffic, and other conditions that may affect travel to time to the new appointment.

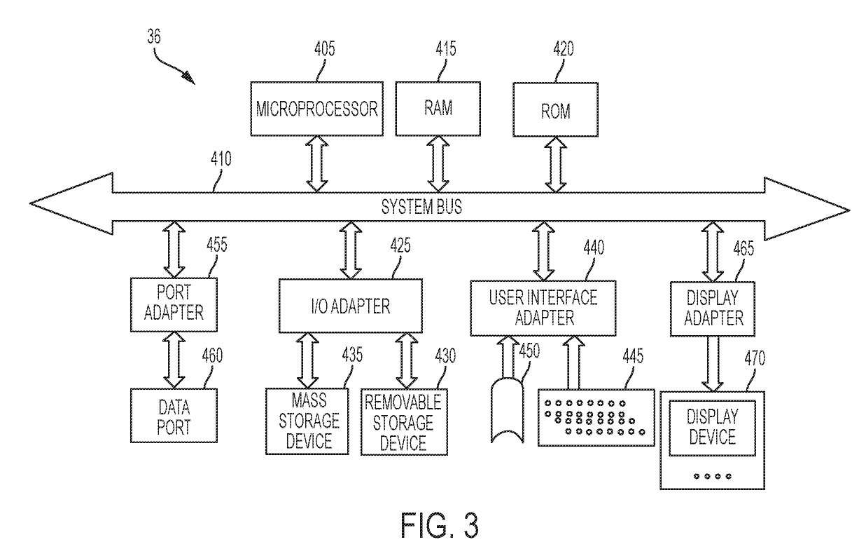

The capabilities of the exemplary embodiments can be implemented in software, firmware, hardware, or some combination thereof. The method may be coded as a set of instructions on removable or hard media for use by the general-purpose computer 36. FIG. 3 presents a block diagram of general-purpose computer 36 suitable for practicing the embodiments of the present invention. In FIG. 3, general-purpose computer 36 has a microprocessor or central processing unit (CPU) 405. CPU 405 is interconnected via a system bus 410 to a random access memory (RAM) 415, a read-only memory (ROM) 420, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470. In accordance with an aspect of an exemplary embodiment, user input adapter 440 may include keyboard 445 and/or mouse 450.

ROM 420 contains the basic operating system for general purpose computer 36. The operating system may alternatively reside in RAM 415 or elsewhere, as is known in the art. Examples of removable data and/or program storage device 430 include magnetic media such as floppy drives and tape drives, and optical media such as CD ROM drives. Examples of mass data and/or program storage device 38 include hard disk drives and non-volatile memory such as flash memory. In addition to keyboard 445 and mouse 450, other user input devices such as trackballs, writing tablets, pressure pads, microphones, light pens, and position-sensing screen displays may be connected to user interface adapter 440. Examples of display devices include cathode-ray tubes (CRT) and liquid crystal displays (LCD).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of scheduling appointments based on a location of a user, the method comprising:
identifying a geographic location of a user;
receiving, through a processor, a new appointment request for a selected day;
determining a location of the new appointment;
determining, through the processor, whether an additional appointment exists for a selected time period including the selected day and adjacent days;
identifying, through the processor, a location of the additional appointment;
determining, through the processor, whether a geographic conflict exists between the location of the new appointment and the location of the additional appointment when receiving the new appointment request; and
providing an alert to the user through a user interface if a geographic conflict exists.

2. The method of claim 1, wherein determining, through the processor, whether the geographic conflict exists includes detecting, through a GPS system, a geographic location of the user.

3. The method of claim 2, wherein detecting, through the GPS system, the geographic location of the user includes detecting a geographic location of one or more of a smart device and a mobile computer employed by the user to input the new appointment request.

4. The method of claim 1, wherein determining, through the processor, whether the geographic conflict exists includes detecting, through an IP address of a computer, a geographic location of the user.

5. The method of claim 1, wherein determining, through the processor, whether the determining the location of the new appointment includes one or more of receiving, from the user, the location of the new appointment, analyzing historical data associated with the location of the new appointment and analyzing information associated with the new appointment.

6. The method of claim 1, further comprising: providing the user with alternative dates for the new appointment request if a geographic conflict exists.

7. The method of claim 1, further comprising: determining, through the processor, whether a geographic conflict exists between the location of the new appointment and the location of the at least one additional appointment on the selected day.

8. The method of claim 7, wherein determining, through the processor, whether the geographic conflict exists between the location of the new appointment and the location of the at least one additional appointment on the selected day includes receiving one or more of a transportation related input and a weather related input.

9. The method of claim 8, wherein receiving one or more of the transportation related input and the weather related input includes receiving traffic information associated with one or more routes between the location of the at least one additional appointment and the location of the new appointment.

10. The method of claim 7, further comprising: providing travel alerts to the user on the selected day.

11. A system for scheduling appointments based on a location of a user comprising:
a central processor unit (CPU);
a non-volatile memory operatively connected to the CPU; and
a calendaring module configured to detect geographic location of a user and an existing appointment, the calendaring module including computer readable program code embodied therewith, the computer readable program code, when executed by the CPU, causes the CPU to:
identify a geographic location of a user;
receive, through a processor, a new appointment request for a selected day;
determine a location of the new appointment;
determine, through the processor, whether an additional appointment exists for a selected time period including the selected day and adjacent days;
identify, through the processor, a location of the additional appointment;
determine, through the processor, whether a geographic conflict exists between the location of the new appointment and the location of the additional appointment when receiving the new appointment request; and
provide an alert to the user through a user interface if a geographic conflict exists.

12. The system of claim 11, wherein the computer readable program code, when executed by the CPU, causes the CPU to: detect a geographic location of the user when determining whether the geographic conflict exists includes detecting a geographic location of the user.

13. The system of claim 11, the computer readable program code, when executed by the CPU, causes the CPU to: determine, through the processor, whether a geographic conflict exists between the location of the new appointment and the location of the at least one additional appointment on the selected day.

14. The system of claim 13, wherein the computer readable program code, when executed by the CPU, causes the CPU to: receiving one or more of a transportation related input and a weather related input when determining, through the processor, whether the geographic conflict exists between the location of the new appointment and the location of the at least one additional appointment on the selected day.

15. The system of claim 13, wherein the computer readable program code, when executed by the CPU, causes the CPU to: provide travel alerts to the user on the selected day.

16. A computer program product comprising:
a computer useable medium including a computer readable program, wherein the computer readable program, when executed on a computer, causes the computer to:
identify a geographic location of a user;
receive, through a processor, a new appointment request for a selected day;
determine a location of the new appointment;
determine, through the processor, whether additional appointment exists for a selected time period including the selected day and adjacent days;
identify, through the processor, a location of the additional appointment;
determine, through the processor, whether a geographic conflict exists between the location of the new appointment and the location of the additional appointment when receiving the new appointment request; and
provide an alert to the user through a user interface if a geographic conflict exists.

17. The computer program product of claim 16, wherein the computer readable program, when executed on a computer, causes the computer to: detect a geographic location of the user when determining, through the processor, whether the geographic conflict exists.

18. The computer program product of claim 16, wherein the computer readable program, when executed on a computer, causes the computer to: determine, through the processor, whether a geographic conflict exists between the location of the new appointment and the location of the at least one additional appointment on the selected day.

19. The computer program product of claim 18, wherein the computer readable program, when executed on a computer, causes the computer to: receiving one or more of a transportation related input and a weather related input when determining, through the processor, whether the geographic conflict exists between the location of the new appointment and the location of the at least one additional appointment on the selected day.

20. The computer program product of claim 18, wherein the computer readable program, when executed on a computer, causes the computer to: provide travel alerts to the user on the selected day.
